(19) United States
(12) Patent Application Publication
(10) Pub. No.: US 2014/0236436 A1
(43) Pub. Date: Aug. 21, 2014

(54) STRUCTURE FOR PREVENTING A BAULKING OF MANUAL TRANSMISSION E-SHIFTER

(71) Applicants: KIA MOTORS CORPORATION, Seoul (KR); HYUNDAI MOTOR COMPANY, Seoul (KR)

(72) Inventors: Jee-Hyuck CHOI, Sungnam-si (KR); Dong-Jae KIM, Gyeongsan-si (KR)

(73) Assignees: KIA MOTORS CORPORATION; HYUNDAI MOTOR COMPANY

(21) Appl. No.: 13/928,004

(22) Filed: Jun. 26, 2013

(30) Foreign Application Priority Data
Feb. 15, 2013 (KR) 10-2013-0016523

(51) Int. Cl. F16H 59/02

(52) U.S. Cl. CPC F16H 59/0204
USPC 701/52

(57) ABSTRACT

A structure for preventing baulking of a manual transmission E-shifter includes a vibration motor disposed in a knob of a manual transmission E-shifter and a return actuator automatically returning the manual transmission E-shifter to a NULL range. The structure makes a driver recognize mis-engagement and automatically shifts to a NULL range by driving the vibration motor and the return actuator, when mis-engagement is generated in a transmission, in a structure of a manual transmission E-shifter, in order to transmit mis-engagement of a manual transmission E-shifter, which is not mechanically connected with the manual transmission, and compensate for the mis-engagement.

### CROSS-REFERENCE TO RELATED APPLICATION

The present application claims priority of Korean Patent Application Number 10-2013-0016523 filed Feb. 15, 2013, the entire contents of which application is incorporated herein for all purposes by this reference.

### TECHNICAL FIELD

The present disclosure relates to a structure for preventing baulking of a manual transmission E-shifter, particularly to a structure for preventing baulking of a manual transmission E-shifter which includes a vibration motor disposed in a knob of a manual transmission E-shifter and a return actuator automatically returning the manual transmission E-shifter to a NULL range, and makes a driver to recognize mis-engagement and automatically shifts to a NULL range by driving the vibration motor and the return actuator.

### BACKGROUND

In general, mis-engagement (baulking) is generated by gear series in relation to shift timing of shifting in manual transmissions used in the related art. FIG. 1 is a perspective view showing a manual transmission mechanism of the related art and FIG. 2 is a side cross-sectional view showing an internal structure of gear series in the manual transmission of the related art.

Baulking, which is generated in the manual transmission mechanism of the related art, is usually caused by bounding between gear series, when timing is not matched between a clutch and gear shifting.

The manual transmission mechanism is generally configured to force a gear to return to the NULL range when baulking is generated due to mis-engagement of gear series.

However, a driver cannot recognize the baulking in a transmission E-shifter, because there is no mechanical link structure, unlike the manual transmissions of the related art.

A need exists for freely informed a driver of mis-engagement status generated when shifting the gear by a driver in an E-shifter of the related art through which a driver has a difficulty in recognizing baulking.

The description provided above as a related art of the present disclosure is merely to help understand the background and should not be construed as being included in the related art known by those skilled in the art.

### SUMMARY

The present disclosure has been made in an effort to provide a structure for preventing baulking of a manual transmission E-shifter which includes a vibration motor disposed in a knob of a manual transmission E-shifter and a return actuator automatically returning the manual transmission E-shifter to a NULL range and to inform a driver of mis-engagement in a transmission and automatically shifts to a NULL range by the return actuator. Further, the present disclosure compensates the mis-engagement for a structure of manual transmission E-shifter when the manual transmission E-shifter is not mechanically connected with a manual transmission. A structure for preventing baulking of a manual transmission E-shifter includes: an automatic transmission control unit; a manual transmission E-shifter; and a transmission which is connected with the Transmission Control Unit (TCU) to generate and transmit a shift fail signal to the TCU when there is a mis-engagement. The TCU generates and transmits a NULL range return signal to the manual transmission E-shifter when receiving the shift fail signal and the manual transmission E-shifter includes a return actuator to adjust a shift range to the NULL range when the NULL range return signal is received.

The TCU further generates and transmits a knob vibration signal to the manual transmission E-shifter when the shift fail signal is received, and the manual transmission E-shifter further includes a motor to generate vibration when the knob vibration signal is received.

The return actuator includes: a motor; a worm gear rotated by the motor; a worm wheel gear rotating in mesh with the worm gear; a lead screw engaged with the worm wheel gear and rotating with the worm wheel gear; a nut engaged with the lead screw and moving in the axial direction of the lead screw as the lead screw rotates; and a mover engaged and moving with the nut, and the mover is engaged with the manual transmission E-shifter and shifts the manual transmission E-shifter when moving.

The manual transmission E-shifter further includes a shock-absorber which includes a pin protruding toward the mover, and the mover has locking portions protruding perpendicularly to the pin at both sides. When the mover moves, the locking portions push the pin and the manual transmission E-shifter is shifted.

The mover moves horizontally.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more power sources for example both gasoline-powered and electric-powered vehicles.

### BRIEF DESCRIPTION OF THE DRAWINGS

The above and other features of the present disclosure will now be described in detail with reference to certain exemplary embodiments thereof illustrated the accompanying drawings which are given hereinbelow by way of illustration only, and thus are not limitative of the present disclosure, and wherein:

FIG. 1 is a perspective view showing a manual transmission mechanism of the related art;

FIG. 2 is a side cross-sectional view showing an internal structure of gear series of a manual transmission mechanism of the related art;

FIG. 3 is a diagram briefly showing the basic configuration of an exemplary embodiment of a structure for preventing baulking of a manual transmission E-shifter of the present disclosure;

FIG. 4 is a perspective view showing a manual transmission E-shifter according to an exemplary embodiment of the present disclosure;

FIG. 5 is a flowchart illustrating operation steps according to an exemplary embodiment of the present disclosure;

FIG. 6 is a view showing a manual transmission E-shifter according to an exemplary embodiment of the present disclosure;

FIG. 7 is a view showing the configuration of a vibration motor in a manual transmission E-shifter according to an exemplary embodiment of the present disclosure;

FIG. 8 is a view showing an embodiment of shift ranges;

FIG. 9 is a perspective view showing the combination structure (a) and the configuration (b) of a return actuator of a manual transmission E-shifter according to an exemplary embodiment of the present disclosure;

FIG. 10 is a perspective view showing the combination structure of the return actuator and a shift lever in a manual transmission E-shifter according to an exemplary embodiment of the present disclosure;

FIG. 11 is a side cross-sectional view of a return actuator; and

FIG. 12 is a plan cross-sectional view of a return actuator seen from above.

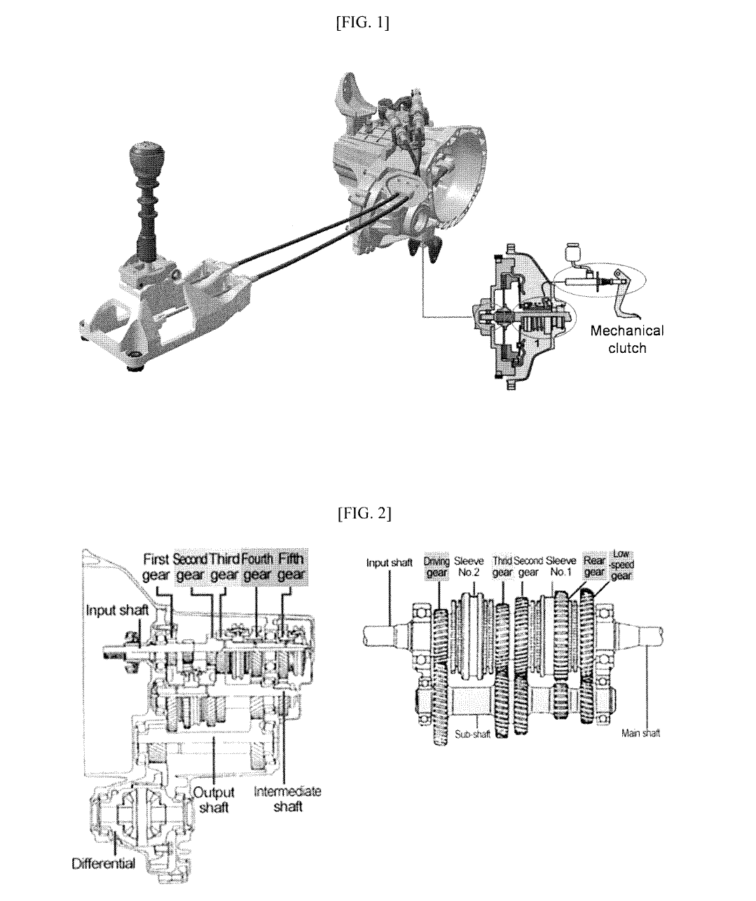

It should be understood that the appended drawings are not necessarily to scale, presenting a somewhat simplified representation of various preferred features illustrative of the basic principles of the present disclosure. The specific design features of the present disclosure as disclosed herein, including, for example, specific dimensions, orientations, locations, and shapes will be determined in part by the particular intended application and use environment.

In the figures, reference numbers refer to the same or equivalent parts of the present disclosure throughout the several figures of the drawing.

### DETAILED DESCRIPTION

The present disclosure relates to a structure for preventing baulking of a manual transmission E-shifter.

Since common manual transmission E-shifter is not mechanically connected with a manual transmission, mis-engagement (baulking) that is generated in the manual transmission is not recognized by a driver.

Therefore, in order to recognize the mis-engagement for the driver, the status of the transmission is checked through a TCU (Transmission Control Unit) of a vehicle, a signal including information on the status of the transmission, such as engagement or mis-engagement of the transmission is transmitted to the manual transmission E-shifter, and the manual transmission E-shifter is allowed to recognize engagement or mis-engagement of the transmission from the transmitted signal.

Further, the manual transmission E-shifter can make a driver to recognize mis-engagement and prevent mis-operation generated from the mis-engagement, by primarily providing vibration to the driver and secondarily forcibly shifting to the NULL range by a return actuator, when the mis-engagement of the transmission is recognized.

Hereinafter, exemplary embodiments of the present disclosure which have the configuration described above will be described in detail with reference to the accompanying drawings.

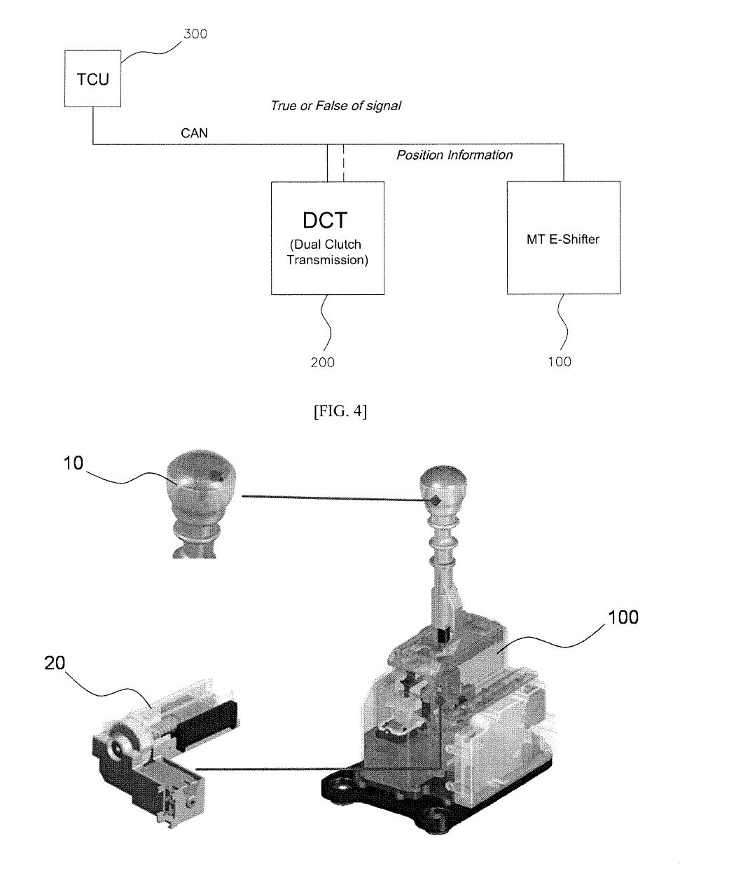

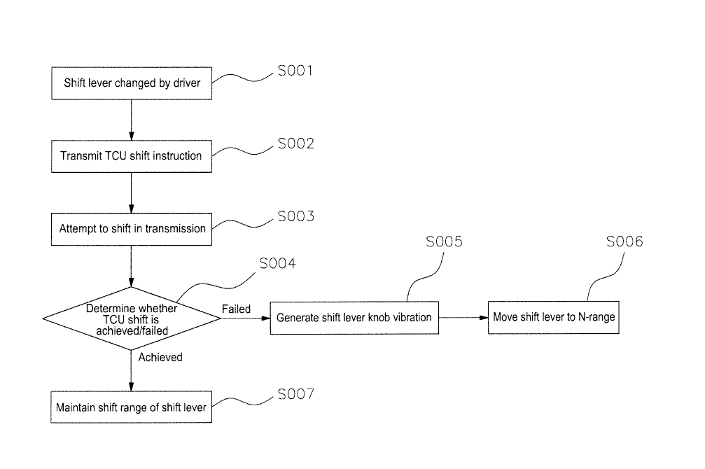

FIG. 3 is a diagram briefly showing the basic configuration of an exemplary embodiment of a structure for preventing baulking of a manual transmission E-shifter of the present disclosure and FIG. 4 is a perspective view showing a manual transmission E-shifter according to an exemplary embodiment of the present disclosure.

As shown in FIG. 3, a structure for preventing baulking of a manual transmission E-shifter 100 of the present disclosure includes a TCU 300, a transmission 200 performing Controller Area Network (CAN) communication with the TCU 300, such as a manual SBW (shift-by-shift) transmission 200, and a manual transmission E-shifter 100.

The structure for preventing baulking of a manual transmission E-shifter 100 of the present disclosure described above makes a driver to recognize baulking in the manual transmission E-shifter and automatically shifts to the NULL range by identifying the status of the transmission 200 through the TCU 300 and transmitting information to the manual transmission E-shifter from the TCU 300 when baulking is generated.

The manual transmission E-shifter 100 includes a vibration motor 10, as shown in FIG. 4, to generate vibration inside a knob for a driver to recognize baulking by the vibration motor 10.

Further, the manual transmission E-shifter 100 includes a return actuator 20 to automatically return the shift range of the manual transmission E-shifter 100 to the NULL range when baulking is generated.

The manual transmission E-shifter 100 may have the same configuration as a manual transmission E-shifter 100 of the related art, except for the vibration motor 10 and the return actuator 20.

FIG. 5 is a flowchart illustrating operation steps according to the exemplary embodiment of the present disclosure.

As shown in the figure, when a driver operates the manual transmission E-shifter 100 (S001), the TCU 300 transmits a shift instruction signal to the transmission 200 by sensing a shift signal from the manual transmission E-shifter and performs CAN communication (S002).

When the shift instruction signal is transmitted from the TCU 300, the transmission 200, attempts to shift (S003), in which shifting may be achieved as required or shifting may be failed by mis-engagement, in other words, baulking.

Therefore, the transmission generates a success signal or a shift fail signal to show success or fail of shifting in accordance with the result after the attempt for shifting and transmits the signal to the TCU 300.

The TCU 300 determines whether shifting by the transmission 200 is achieved successfully or failed by receiving the shift signal (S004), and when a success signal is received from the transmission 200, it controls the shift range of the manual transmission E-shifter such that the shift range remains in a normal range.

When a fail signal is received from the transmission 200, the TCU 300 generates a knob vibration signal and a NULL range return signal and transmits the signals to the manual transmission E-shifter 100.

Therefore, the manual transmission E-shifter 100 generates vibration by driving the vibration motor 10 in the knob of the manual transmission E-shifter in response to the knob vibration signal (S005) and returns the lever of the manual transmission E-shifter to the NULL range by driving the return actuator 20 in response to the NULL range return signal (S006).

Accordingly, when shifting to a shift range is failed by baulking, the driver can recognize the fail of shifting by the vibration motor 10 and then can recognize that the shift range is automatically shifted to the NULL range.

In another exemplary embodiment of the present disclosure, when shifting to a shift range is failed, only one of the knob vibration signal and the NULL range return signal may be transmitted to the manual transmission E-shifter and only one of vibration of the knob and return to the NULL range of the shift range may be performed.

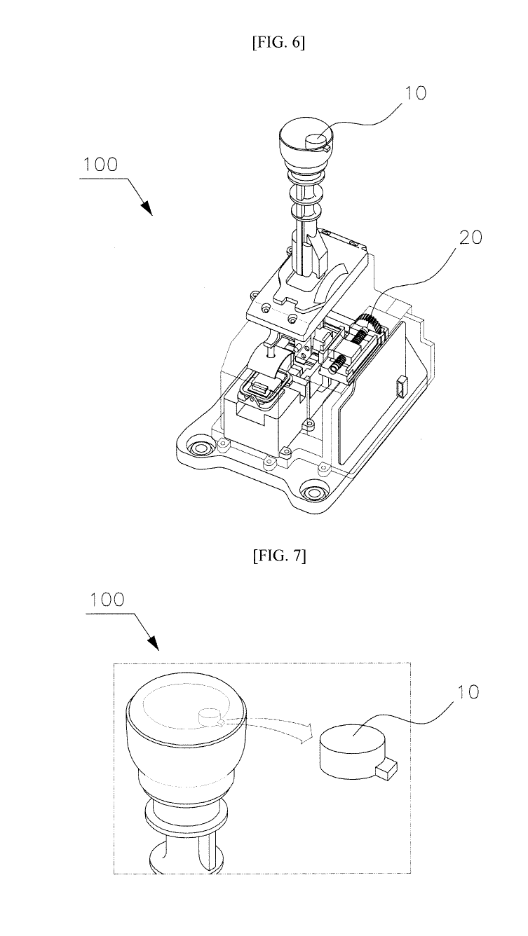

FIG. 6 is a view showing a manual transmission E-shifter according to an exemplary embodiment of the present disclosure and FIG. 7 is a view showing the configuration of a vibration motor in the manual transmission E-shifter according to an exemplary embodiment of the present disclosure.

Preferably, the vibration motor 10 is disposed in the knob of the manual transmission E-shifter and controlled by an ECU (Electronic Control Unit) of the manual transmission E-shifter.

Therefore, when the ECU of the manual transmission E-shifter receives the knob vibration signal from the TCU 300, the vibration motor 10 is controlled by the ECU of the manual transmission E-shifter to operate and generate vibration, so that the driver holding the knob of the manual transmission E-shifter recognizes that baulking of the shift range has been generated, through vibration.

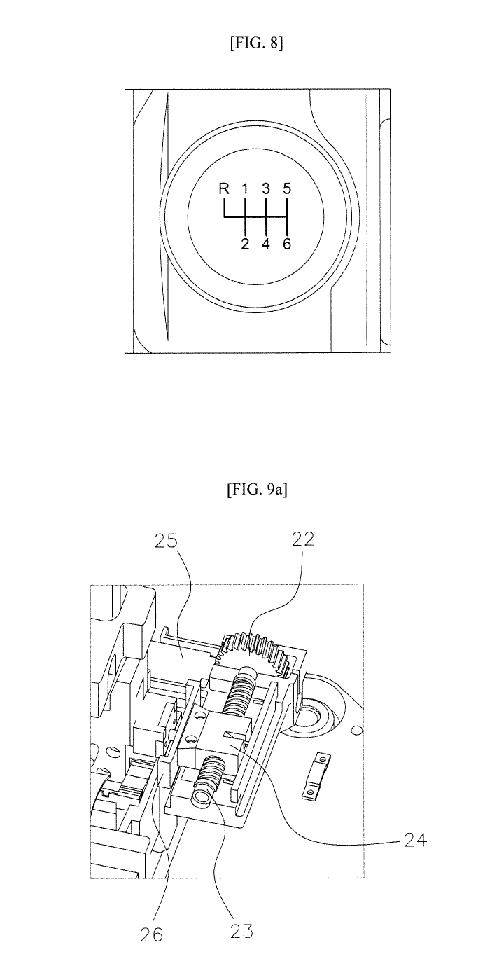

The vibration motor 10 is driven by the knob vibration signal regardless of the shift range, that is, the position of the knob, so that, as shown in FIG. 8, when baulking is generated in shifting, vibration can be generated irrespective of the shift range where the knob is positioned.

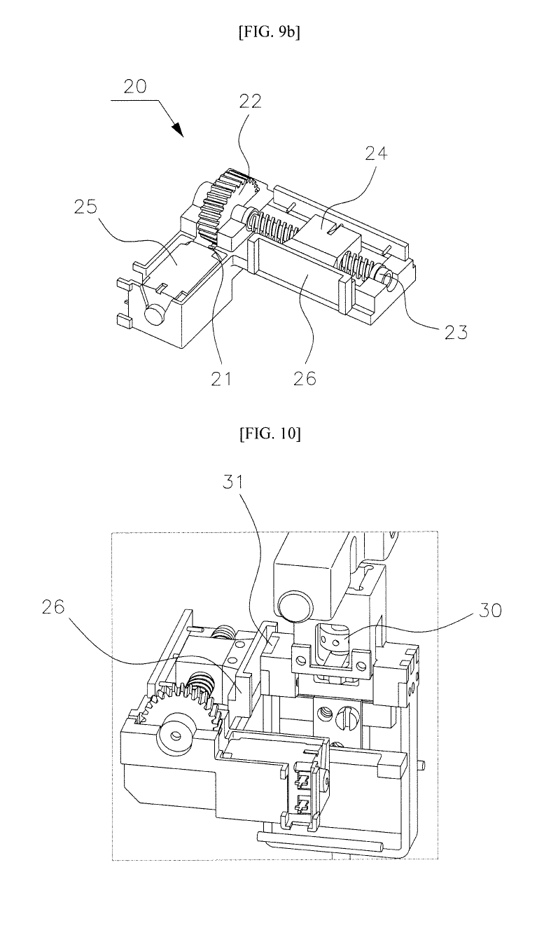

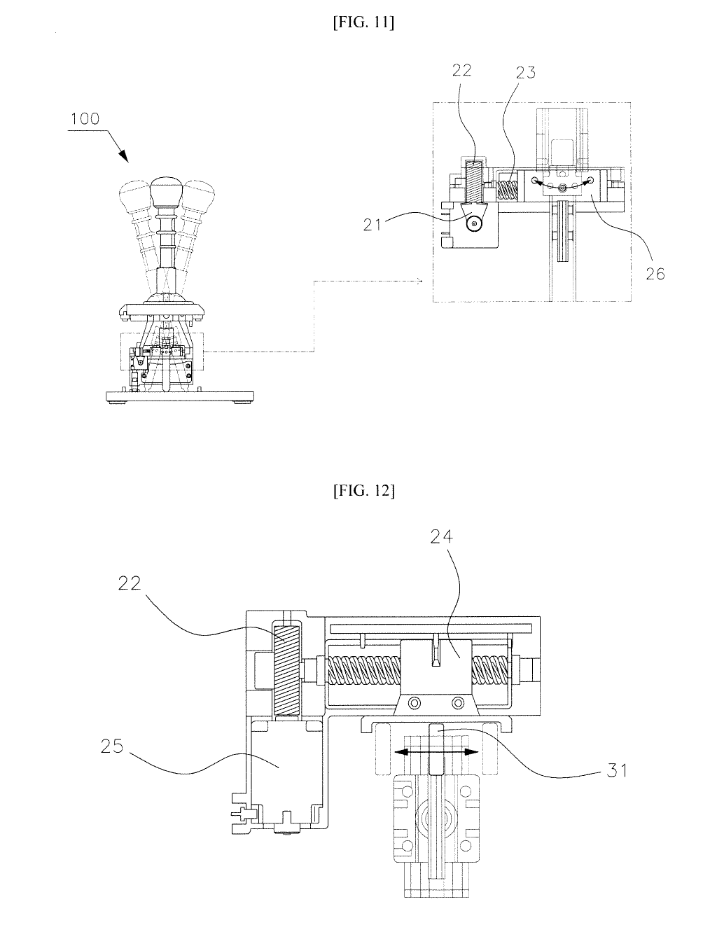

FIGS. 9a and 9b are perspective views showing, (a) the combination structure and (b) the configuration of the return actuator 20 of the manual transmission E-shifter according to an exemplary embodiment of the present disclosure, FIG. 10 is a perspective view showing the combination structure of the return actuator 20 and a shift lever in a manual transmission E-shifter according to an exemplary embodiment of the present disclosure, FIG. 11 is a side cross-sectional view of the return actuator, and FIG. 12 is a plan cross-sectional view of the return actuator seen from above.

As shown in FIGS. 9(a) and 9(b), the return actuator 20 according to an exemplary embodiment of the present disclosure includes a motor 25, a worm gear 21 rotated by the motor 25, a worm wheel gear 22 rotating in mesh with the worm gear 21, a lead screw 23 engaged with the worm wheel gear 22 and rotating with the worm wheel gear 22, a nut 24 engaged with the lead screw 23 and moving in the axial direction of the lead screw 23 when the lead screw 23 rotates, and a mover 26 engaged with the nut 24 and moving with the nut 24.

Therefore, the return actuator 20 is operated by the operation of the motor 25, the rotation of the motor 25 is transmitted to the lead screw 23 by the worm gear 21 and the worm wheel gear 22, and the nut 24 is moved by the rotation of the lead screw 23 and moves the mover 26 engaged with the nut 24, so that the lever is automatically return to the NULL range.

As shown in FIG. 10, the return actuator 20 is connected with a rod shock-absorber (Rod S/A) 30 of the manual transmission E-shifter by the pin 31 protruding to the mover 26.

The mover 26 has locking portions protruding perpendicularly to the pin 31, where pin 31 is disposed between the locking portions so that as the mover 26 moves, the locking portions push the pin 31 and move shock-absorber 30, and accordingly, the manual transmission E-shifter shifts the shift range.

Therefore, when a driver operates the manual transmission E-shifter, the rod shock-absorber 30 is driven too, and the mover 26, which is fastened to the rod shock-absorber 30 by the pin 31, is moved in the axial direction of the lead screw 23 by pressure from the rod shock-absorber 30.

Therefore, it is preferable that the mover 26 is disposed along the movement path of the rod shock-absorber 30, preferably, horizontally.

The operation step of the return actuator 20 is as follows.

1. The motor 25 is driven.

2. The worm gear 21 connected with the motor 25 is operated.

3. The worm wheel gear 22 engaged with the worm gear 21 is driven.

4. The lead screw 23 engaged with the worm gear 22 is rotated by the operation of the worm wheel gear 22.

5. The nut 24 is axially moved straight by the rotation of the lead screw 23.

6. The mover 26 engaged with the nut 24 is axially driven by the movement of the nut 24.

7. The pin 31 engaged with the mover 26 is operated by the movement of the mover 26.

8. The rod shock-absorber 30 connected with the pin 31 is forcibly driven.

9. The shift range is returned to the NULL range regardless of the current range.

Therefore, the structure for preventing baulking of the manual transmission E-shifter 100 of the present disclosure is configured such that a shift range is shifted to the NULL range by the return actuator.

Although exemplary embodiments of the structure for preventing baulking of the manual transmission E-shifter of the present disclosure are only specific examples for helping understanding of the present disclosure, but not limiting the scope of the present disclosure. It is apparent to those skilled in the art that the present disclosure may be modified in various ways on the basis of the spirit of the present disclosure other than the embodiments described herein.

What is claimed is:

1. A structure for preventing baulking of a manual transmission E-shifter, comprising:
an automatic transmission control unit;
a manual transmission E-shifter; and
a transmission,
wherein the transmission is connected with a Transmission Control Unit (TCU) and generates and transmits a shift fail signal to the TCU when mis-engagement is generated,
the TCU generates and transmits a NULL range return signal to the manual transmission E-shifter when receiving the shift fail signal, and
the manual transmission E-shifter includes a return actuator and returns a shift range to the NULL range by driving the return actuator when receiving the NULL range return signal.

2. The structure of claim 1, wherein the TCU further generates and transmits a knob vibration signal to the manual transmission E-shifter when receiving the shift fail signal, and
the manual transmission E-shifter further includes a vibration motor and drives the vibration motor when receiving the knob vibration signal.

3. The structure of claim 1, wherein the return actuator includes:
a motor;
a worm gear rotated by the motor;
a worm wheel gear rotating in mesh with the worm gear;
a lead screw engaged with the worm wheel gear and rotating with the rotation of the worm wheel gear;
a nut engaged with the lead screw and moving in the axial direction of the lead screw when the lead screw rotates; and
a mover engaged with the nut and moving with the nut, and
the mover is engaged with the manual transmission E-shifter and shifts the manual transmission E-shifter when moving.

4. The structure of claim 3, wherein the manual transmission E-shifter further includes a rod shock-absorber,
the rod shock-absorber includes a pin protruding toward the mover,
the mover has locking portions protruding perpendicularly to the pin, at both sides, and
when the mover moves, the locking portions push the pin and the manual transmission E-shifter is shifted.

5. The structure of claim 4, wherein the mover moves horizontally.
